(19) United States
(12) Patent Application Publication
(10) Pub. No.: US 2017/0101333 A1
(43) Pub. Date: Apr. 13, 2017

(54) Closing Mechanism for a Glassware Forming Machine

(71) Applicant: Heye International GmbH, Obernkirchen (DE)

(72) Inventors: Benedikt Felgenhauer, Herford (DE); Daniel Hardekopf, Lauenhagen (DE)

(21) Appl. No.: 15/287,773

(22) Filed: Oct. 7, 2016

(30) Foreign Application Priority Data
Oct. 7, 2015 (DE) 202015006975.4

(51) Int. Cl. C03B 11/16

(52) U.S. Cl. CPC C03B 11/16

(57) ABSTRACT

A closing mechanism for at least two mold halves (4, 5) held by two mold holders (7, 8) includes a drivetrain suspended under the housing section (3) inside of the station housing. The mold holders (4, 5) are mounted on a linear guide and are joined with a threaded spindle, threaded sleeve and gearing with a drive set up on the outlet side for generating a vertically oriented linear movement. A toggle-lever mechanism situated inside of an oil bath accommodated in the station housing (1) is used as the gearing. This arrangement of essential components of the drivetrain opens allows removal of the drivetrain via the upper side of the station housing when necessary or incorporating the drivetrain into the station housing, thereby simplifying repair and maintenance work.

### CROSS-REFERENCE TO RELATED APPLICATIONS

The instant application claims the priority date of Oct. 7, 2015, the filing date of the German patent application DE 20 2015 006 975.4.

### BACKGROUND OF THE INVENTION

The invention relates to a closing mechanism for mold halves of a glassware forming machine.

These closing mechanisms for glassware forming machines are known in a variety of forms. For example, DE 33 46 466 A1 describes a device for opening and closing the preforms of a glassware forming machine, in which the opening and closing movement is established by the parallel movement of two mold halves caused by a drive, which conveys the vertically directed linear movement of a piston-cylinder unit via interspersed levers to two crankshafts extending parallel to and spaced apart from each other, whose rotational movements are converted by these connected cranks into uniform, opposite movements of the mold halves. The piston-cylinder unit along with the remaining elements of the drive are laterally at the same height as the mold halves.

Another device comparable to the above is known from DE 695 09 946 T2, in which the drive elements for a parallel closing mechanism of a glassware forming machine are positioned laterally at the same height with the mold halves. The drive is otherwise characterized by a piston-cylinder unit.

The disadvantage of these known embodiments is that the lateral drive elements take up installation space on the station box, so that the latter is not available at this location for other functional elements. Establishing reliable lubrication requires a central lubricating connection in addition to a line system that incorporates the latter, wherein excess lubricating oil must be caught in a collection tank. The use of Teflon-coated tin cans that serve to reduce wear in linkage mechanisms, e.g., toggle-lever mechanisms, does not make sense, since rotation under a load destroys the Teflon coating and yields a clearance that detracts from a positionally accurate, in particular reproducible, movement of the mold halves during a closure movement. Subsequent lubrication is also not possible during the ongoing operation of the glassware forming machine. Finally, the drivetrains known from the state of the art enable only a very incomplete application of the advantages associated with a servomotor in view of the rotor position, which changes constantly due to wear.

EP 0555 956 A1 describes a forming mechanism for the mold halves of a glassware forming machine that can move parallel to each other between an opening and closing position, in which the vertical movement of the piston rod of a piston-cylinder unit is converted by means of a coupler mechanism comprised of two connection pieces into two horizontally oppositely directed partial movements making up the closing and opening movement of the mold halves. This mechanism has essentially come to be further configured in such a way that the closing position of the molds relative to the central axis of this mechanism is set by aligning the effective direction of the piston rod. This mechanism is characterized by the fact that, in the closing position of the two connection pieces, only a small portion of the force conveyed via the piston-cylinder unit is available as a closing force.

The parallel closing mechanism for the mold halves of a glassware forming machine described in WO 2010/102590 A2 is characterized by the fact that a separate drive is allocated to each mold half. To this end, two drivetrains are provided, each of which consists of a suspended motor and a planetary gear, whose initial movement can be converted by means of a disk that eccentrically accommodates a bolt into a back-and-forth, opening and closing movement of the mold carriers bearing the mold halves. The use of two separate drivetrains provides a comparatively complex structure.

### SUMMARY OF THE INVENTION

The object of the invention is to improve a parallel closing mechanism of the kind noted above from the standpoint of wear and maintenance with an eye toward a simple constructive design. This object is achieved in such a parallel closing mechanism according to the present invention.

It is essential to the invention that all components of the drivetrain are accommodated under an upper side of the station housing, wherein the mold holders are mounted on a guide located inside of a lateral housing section above the upper side of the station housing. As a consequence, the lower side of this housing section establishes a connection to the drivetrain. When needed, the upper side of the station housing comprised of the plate or a cover offers the ability to remove the complete drivetrain via the specified upper side out of the station housing or build it into the latter. This significantly simplifies repair and maintenance work, since the complete station housing had to be replaced if damage occurred to the gearing in known embodiments of closing mechanisms, which is associated with a significantly increased level of effort.

The drivetrain preferably is suspended under the housing section. Accordingly, the closing mechanism according to the invention can be upwardly completely removed from the station housing and inserted the other way.

The guide is preferably a linear guide and accommodated inside of the lateral housing section. As a consequence, a parallel closing mechanism is preferably involved. The guide system can be established by sliding bushes guided on steel rods or also by precision rails, which bear guiding elements mounted on rolling elements.

The drive used as described in the invention is preferably one that generates a vertically directed linear movement on the outlet side. To this end, all drives known to the practitioner in the relevant technology can basically be used for this purpose.

The present invention contemplates advantageous drives that are structurally easy to create. Conceivable here, for example, is a motor whose vertically extending axis is drivingly connected with a threaded spindle, which can be used to create a vertically linear movement by way of a threaded sleeve. However, another possibility involves a pneumatically activatable piston-cylinder unit, whose axis extends vertically.

According to an embodiment, the mold holders are mounted by means of mounting plates, which are mounted on the guide via guide elements. This can be accomplished using both rolling elements and sliding bushes.

The gearing of the drivetrain preferably is set up in such a way that the inlet side, vertically oriented linear movement branches into two horizontally directed movements that are opposite each other, yet symmetrical relative to a vertical central plane. These are the movements to be directly conveyed to the mentioned mounting plates.

According to an embodiment, the gearing preferably is a toggle lever mechanism or at least encompasses a toggle lever mechanism.

With regard to lubrication aspects, according to one embodiment, an oil bath is provided, which completely accommodates at least the gearing, so that a distinct reduction in wear can be achieved as the result of permanent contact with lubricating oil. Another advantage to the oil bath lies in the fact that wear-resistant bushes pressed into the gearing area can be used. The oil bath is designed to make checking fill levels easy, thereby enabling a timely refilling as needed. In addition to the mentioned gearing, the oil bath can also include parts of the drive, such as a threaded spindle, a piston rod, etc.

According to the invention, the gearing preferably is mounted by means of the receptacle that accommodates the oil bath. The receptacle comprises an assembly that is easy to install in the station housing or remove therefrom. Thus, the closing mechanism according to the invention is situated so that it can be easily and quickly changed out.

According to a further embodiment of the invention, the lubricating system may be a central lubricating system, which is used to supply parts outside of the oil bath that require lubrication. This relates in particular to the above-noted guide along with the guiding elements that interact with the latter. Significant here is that each lubrication point is equipped with its own lubricant line, proceeding from a lubricating oil distributor. This opens the door to being able to individually check the function of the lubricating supply for each lubrication point. Lubrication is preferably triggered at intervals in conjunction with a machine controller.

According to a further embodiment, a toggle-lever mechanism according to the invention may be accommodated completely inside of the station housing, under the above-noted upper side and inside of the oil bath.

According to another embodiment, the toggle-lever mechanism is mounted in the receptacle that accommodates the oil bath.

As evident, the closing mechanism according to the invention provides an easily reparable, kinematically clear system that also incorporates lubrication aspects.

### BRIEF DESCRIPTION OF THE DRAWINGS

The invention will be explained in greater detail below with reference to the exemplary embodiment depicted in the drawings. Shown on:

FIG. 1 is a perspective, left-side view of a station housing with a closing mechanism according to the invention in a closing position;

FIG. 2 is a perspective, right-side view of the station housing with a closing mechanism according to the invention in the opening position;

FIG. 3 is a sectional view of the drivetrain in a plane III-III of FIG. 7;

FIG. 4 is a magnified partial illustration of a detail IV of FIG. 3;

FIG. 5 is a sectional view of the station housing in a plane V-V of FIG. 7;

FIG. 6 is an outer view of the station housing according to FIG. 5, with its front wall omitted and in the opposite viewing direction;

FIG. 7 is a right-side view of the station housing in a partially sectional illustration;

FIG. 8 is a magnified partial illustration of a detail VIII of FIG. 7;

FIG. 9 is a magnified partial view of a detail IX of FIG. 10;

FIG. 10 is a left-side view of the station housing in a partially sectional illustration;

FIG. 11 is a planar view of a cross section of the closing mechanism according to the invention;

FIG. 12 is an isometric view of the closing mechanism according to FIG. 11;

FIG. 13 is an isometric central partial view of the closing mechanism according to the invention;

FIG. 14 is a depiction of the lubricating oil supply in a longitudinal section of the station housing;

FIG. 15 is a magnified partial illustration of a detail XV of FIG. 14;

FIG. 16 is a magnified partial illustration of the drivetrain of the closing mechanism according to the invention; and

FIG. 17 is a magnified partial illustration of the lubricating oil supply in a cross section of the station housing.

### DETAILED DESCRIPTION OF THE PREFERRED EMBODIMENTS

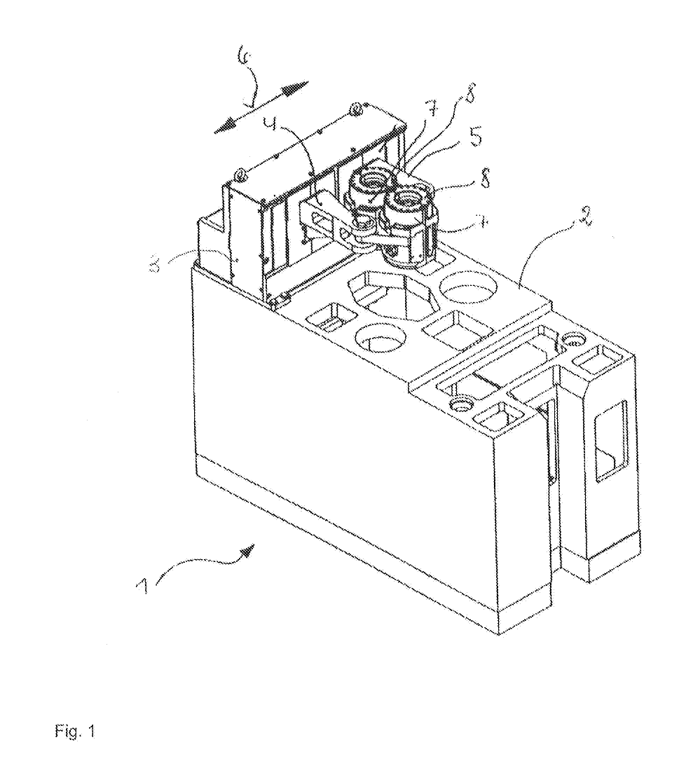

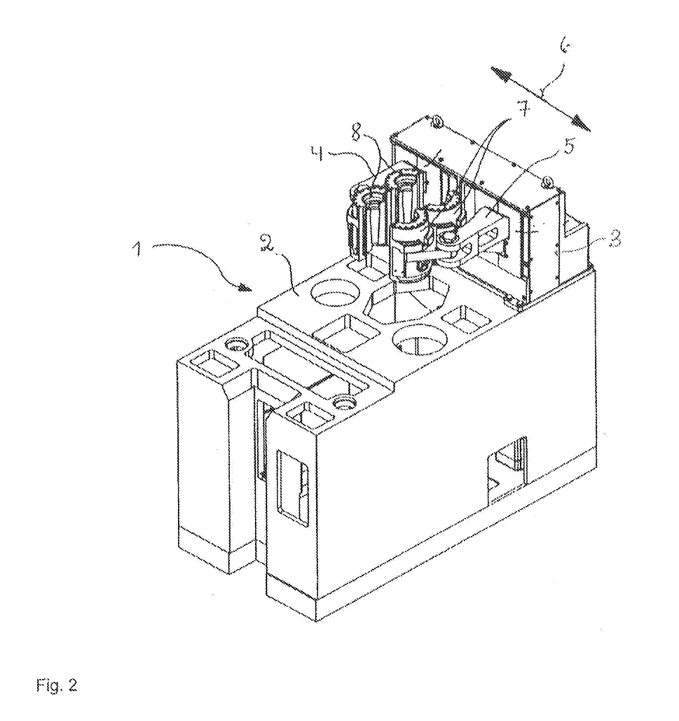

A globally square station housing is marked 1 on FIG. 1 and FIG. 2, whose upper side 2 has located on it a housing section 3 that comprises a traverse, on which are arranged two mold holders 4, 5 that can be linearly displaced horizontally in the direction of the arrows 6 between a closing position shown on FIG. 1 and an opening position shown on FIG. 2. Each of the mold holders 4, 5 carries two mold halves 7, 8, which are preform halves of a glassware forming machine, in particular of an I.S. machine (“Individual Section” machine).

As yet to be described below, the housing section 3 is set up to accommodate the structural elements intended for linearly guiding the mold holders 4, 5 in the direction of the arrows 6, wherein a motor along with accompanying gear elements are accommodated under the housing section 3, and hence inside of the station housing 1.

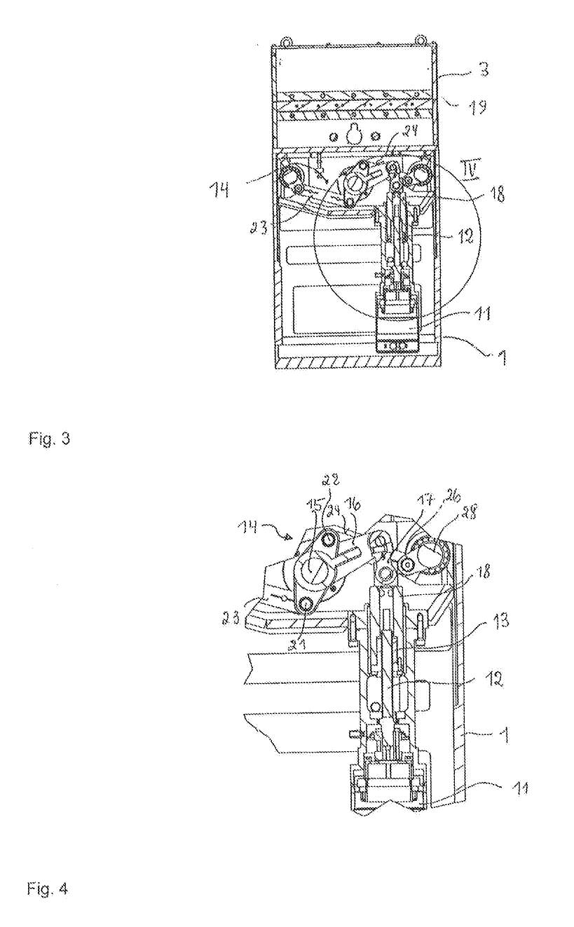

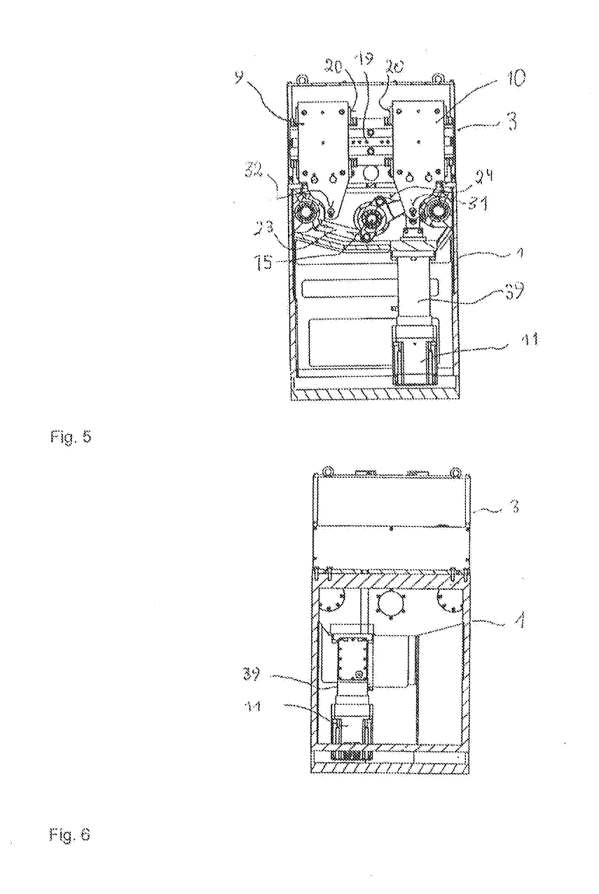

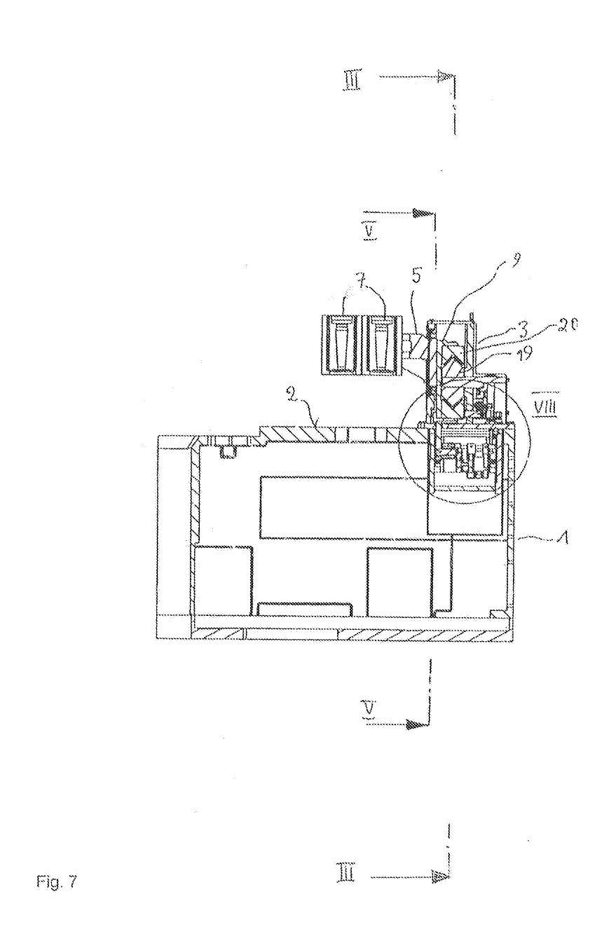

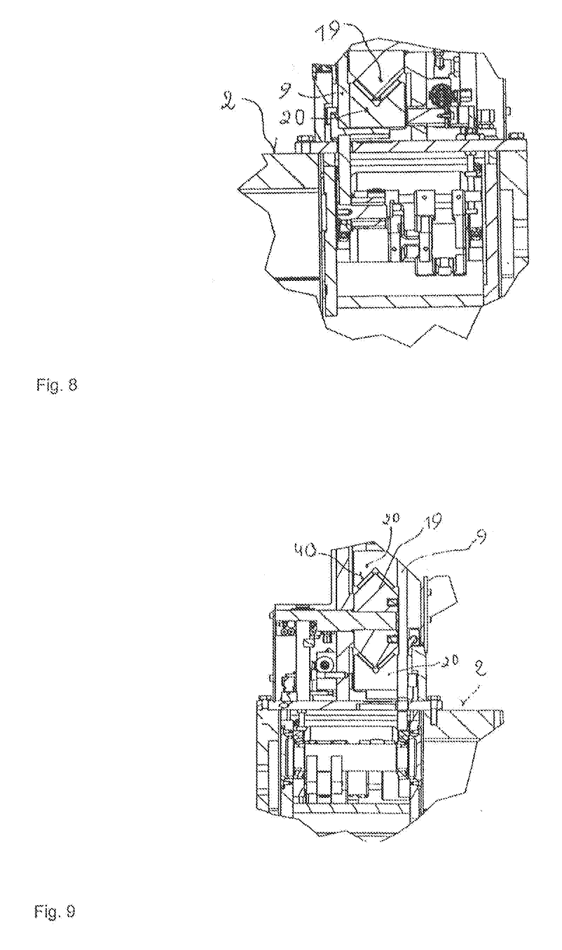

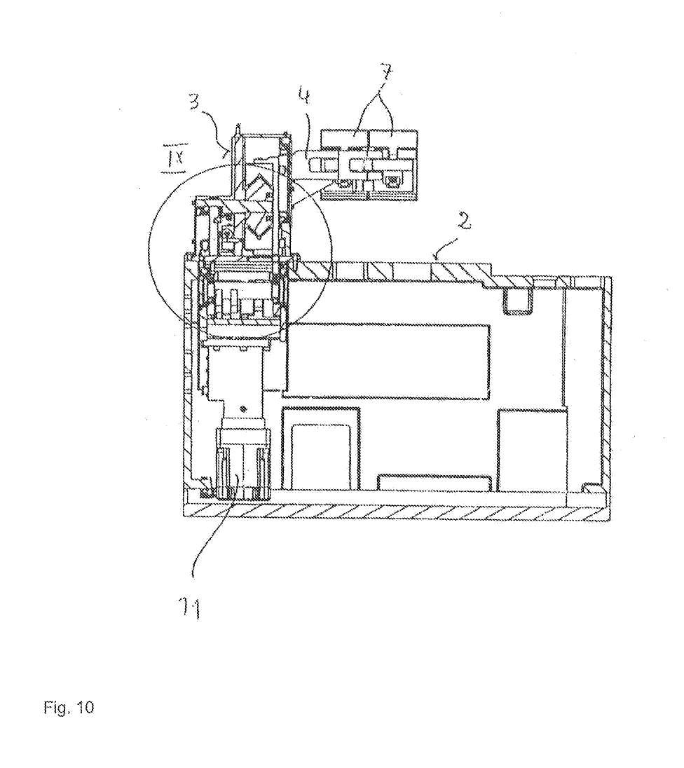

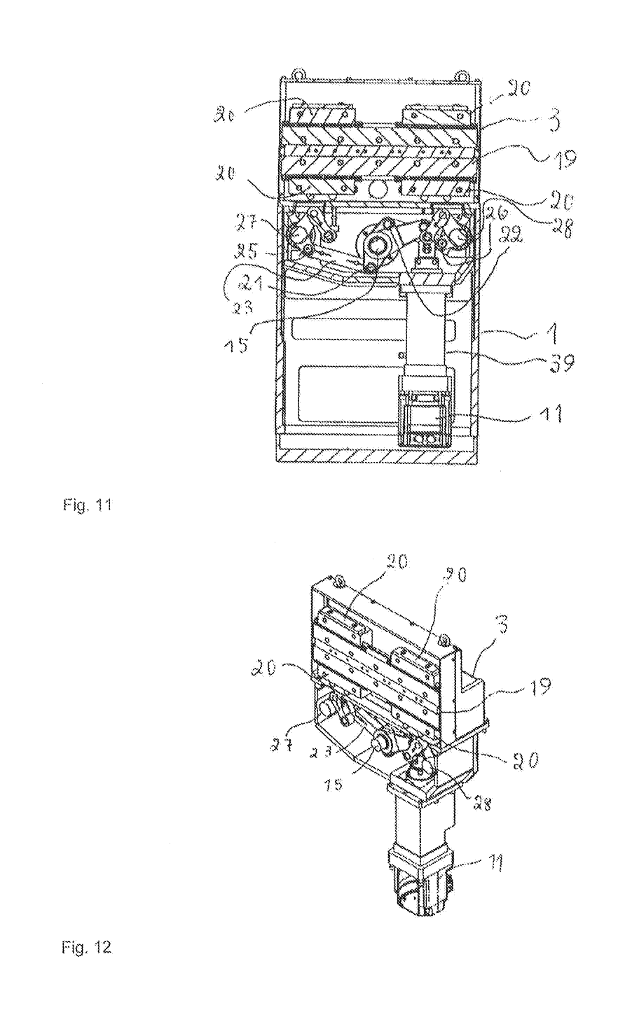

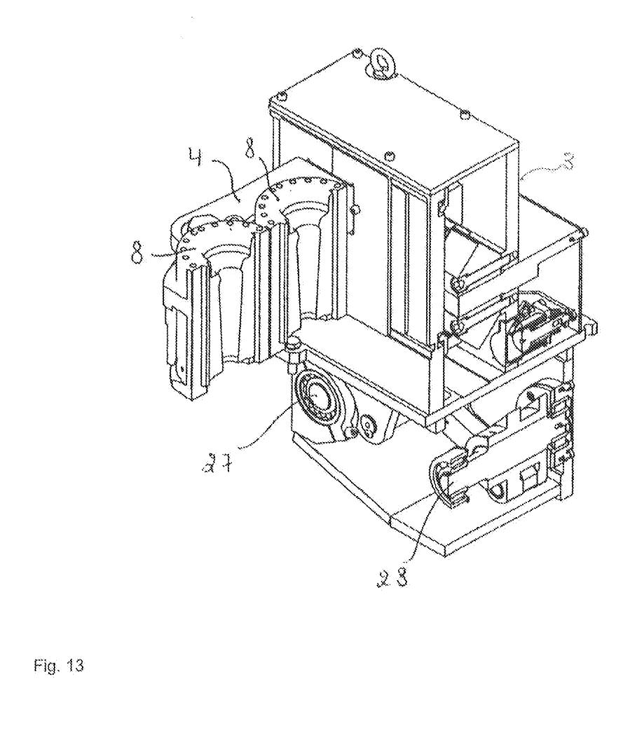

Reference will additionally be made below to FIGS. 3 to 17, in which functional elements that coincide with those on FIGS. 1 and 2 are correspondingly numbered, eliminating the need for another description relating thereto.

The mold holders 4, 5 are secured to mounting plates 9, 10, which comprise the linking member to the remaining elements of the drivetrain of the closing mechanism. The drivetrain consists of a motor 11, whose axis also extends vertically inside of the station housing 1 and is joined with a uniaxial threaded spindle 12, which is set up by way of a threaded sleeve 13 for introducing a vertically directed linear movement in a toggle-lever mechanism 14.

The mounting plates 9, 10 are joined with a horizontal linear guide 19, which is formed by a rail profile, along which the opening and closing movement of the mold halves 7, 8 is set up. The rail profile of the linear guide 19 is situated inside the housing section 3, and provided with beveled upper and lower sides that run symmetrically to a vertical central plane, against which abut guiding elements 20 mounted via cylindrical rolling elements 40 and fastened to the mounting plates 9, 10.

The toggle-lever mechanism 14 encompasses a central shaft 15, which is joined by a lever 16 and intermediate lever 17 with a rod 18, which for its part is set up to transfer a vertical movement, and in so doing to introduce a rotational movement into the shaft 15.

The shaft 15 is provided with two spherical bearings 21, 22 lying symmetrically opposite each other, into which are hinged levers 23, 24 that for their part are joined with spherical bearings 25, 26 non-rotatably connected with shafts 27, 28 by means of intermediate levers 29, 30. The overall system comprised of the shafts 15, 27 and 28, the levers 23, 24 along with the intermediate levers 29, 30 forms a symmetrical structure relative to the central shaft 15, so that turning the shaft 15 or linearly moving the rod 18 can create symmetrically opposite rotational movements of the shafts 27, 28.

The mounting plates 9, 10 are each hinged by way of a bolt 31, 32 to an intermediate lever 33, 36, which for its part is non-rotatably connected with the shaft 27, 28 by means of a connecting lever 34, 35, thereby forming a knee joint on the sides of the shafts 27, 28 facing each other. Due to the symmetrical characteristics of the toggle-lever mechanism 14 relative to a vertical central plane running through the shaft 15, vertical movements of the drive thus create movements of the mounting plates 9, 10, and hence of the mold halves 7, 8, that are identical, yet opposite to each other.

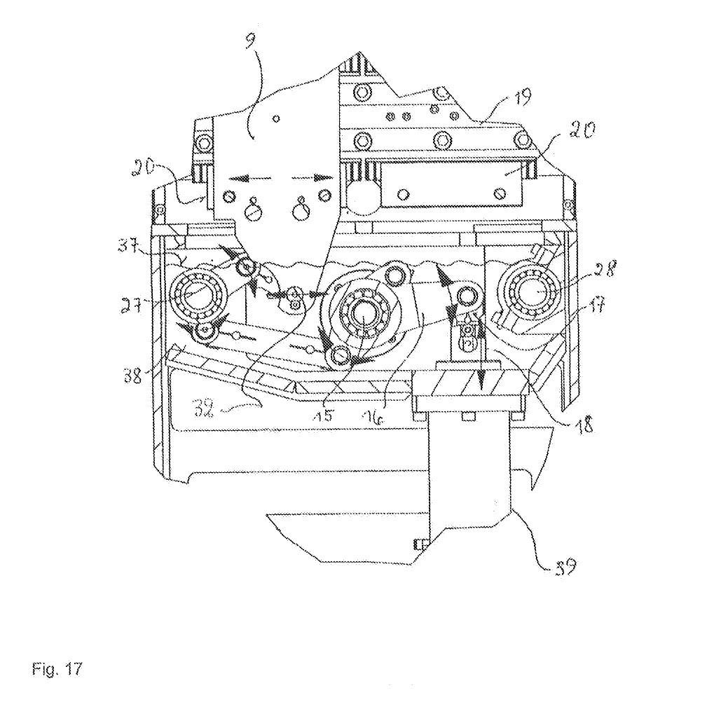

Arrows on FIG. 17 illustrate the kinematically interconnected movements of the individual transfer elements between the drive and mounting plates 9, 10.

Essential in this regard is that all elements of the drive are arranged under the upper side 2 of the station housing, so that this upper side 2 can be used as a modular plate.

As may be gleaned in detail from FIG. 17, an oil bath 37 is set up inside of the station housing for lubricant supply purposes, specifically right under the housing section 3. To this end, a receptacle 38 that in particular accommodates the toggle-lever mechanism 14 is provided, which is filled with lubricating oil up to a fill level corresponding roughly to the position of the bolt 31, 32. The oil bath 37 includes a housing section 39, inside of which the threaded spindle 12 is mounted, and inside of which the threaded sleeve 13 is guided. Also incorporated in the oil bath 37 are the lower ends of the mounting plates 9, 10, and hence the bolts 31, 32 present in this location.

The shafts 15, 27, 28 of the toggle-lever mechanism 14 are mounted in the walls of the receptacle 38, so that the suspended arrangement of the drivetrain makes it possible to insert or remove the closing mechanism as a uniform assembly via the upper side 2 of the station housing 1.

As evident, the gearing, here essentially a toggle-lever mechanism 14, present between the drive, here the motor 11, and mounting plates 9, 10 is exposed to an especially reliable lubrication effect, since it is accommodated in an oil bath.

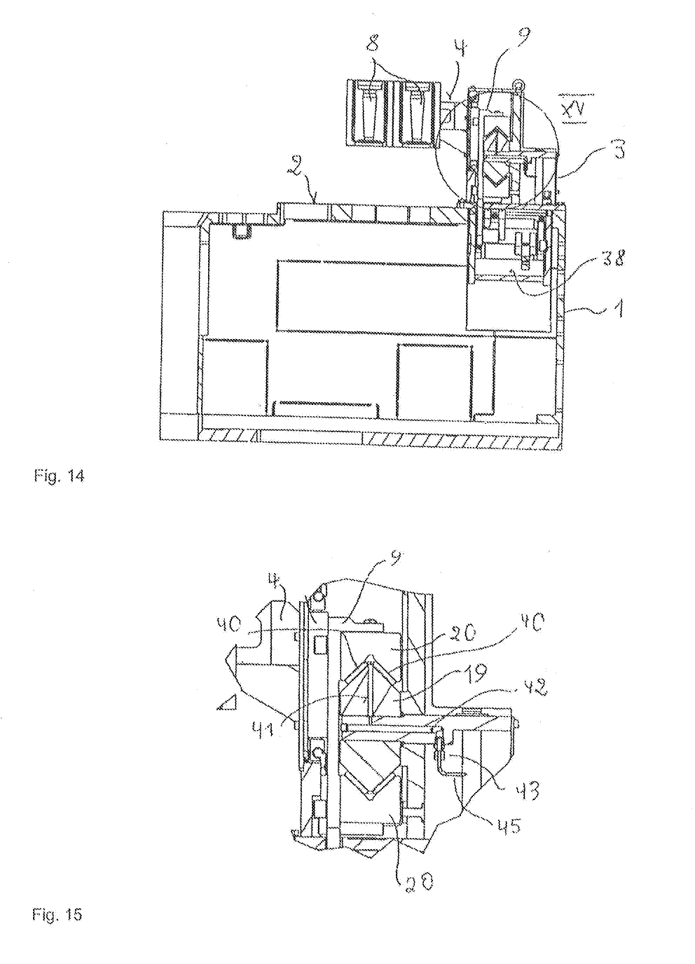

A central lubricating system is provided for other components to be lubricated, here in particular the linear guide 19 and the guiding elements 20 interacting with the latter, the central lubricating interacting interacts with a lubricant pump (not shown in the drawings) to establish a connection with the individual lubrication points. In this conjunction, FIGS. 14 and 15 solely by way of example depict the linear guide equipped with cylindrical rolling elements 40, which are continuously joined with a connection point, here a screw connection 43, by way of one or preferably several lubricating lines 41, 42 that empty into the respective tip of the cross sectional profile of the guide.

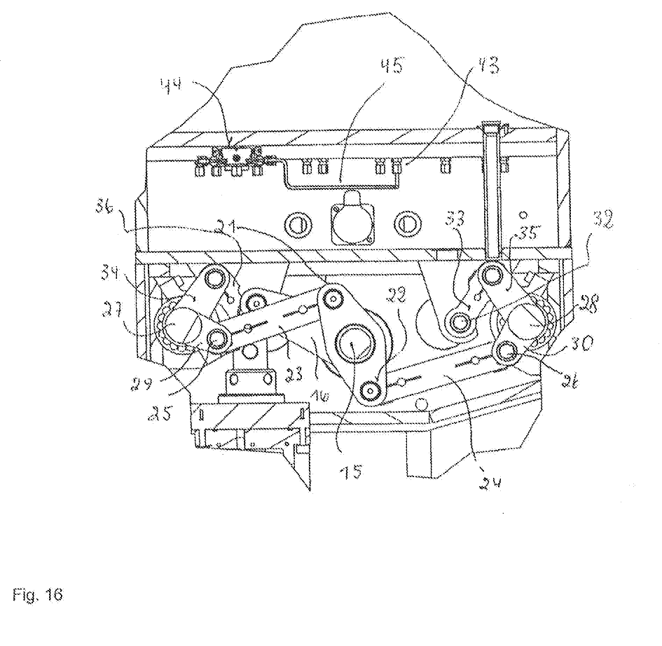

FIG. 16 shows a lubricating oil distributor 44, which is joined with the individual screw connections 43 via line sections 45. Each lubrication point preferably has a line section 45 allocated to it.

Lubrication is initiated in conjunction with a machine controller based on selectable points in time, wherein, if a line section 41, 42, 45 were to be jammed or no flow were to be on hand for some reason, an interference signal is triggered, so that the function of the lubricant system is in this regard automatically monitored.

The features of the subject matter of this invention set forth in the above description, the patent claims, the abstract and the drawings can be used individually and in any desired combination for the realization of the invention in its various embodiments.

The specification incorporates by reference the disclosure of DE 20 2015 006 975.4, filed Oct. 7, 2015.

The present invention is, of course, in no way restricted to the specific disclosure of the specification and drawings, but also encompasses any modifications within the scope of the appended claims.

Reference Numeral List:

| | |
|---|---|
| 1. | Station housing |
| 2. | Upper side |
| 3. | Housing section |
| 4. | Mold holder |
| 5. | Mold holder |
| 6. | Arrows |
| 7. | Mold half |
| 8. | Mold half |
| 9. | Mounting plate |
| 10. | Mounting plate |
| 11. | Motor |
| 12. | Threaded spindle |
| 13. | Threaded sleeve |
| 14. | Toggle lever mechanism |
| 15. | Shaft |
| 16. | Lever |
| 17. | Connecting lever |
| 18. | Rod |
| 19. | Linear guide |
| 20. | Guide element |
| 21. | Pivot bearing |
| 22. | Pivot bearing |
| 23. | Lever |
| 24. | Lever |
| 25. | Pivot bearing |
| 26. | Pivot bearing |
| 27. | Shaft |
| 28. | Shaft |
| 29. | Intermediate lever |
| 30. | Intermediate lever |
| 31. | Bolt |
| 32. | Bolt |
| 33. | Connecting lever |
| 34. | Connecting lever |
| 35. | Intermediate lever |
| 36. | Intermediate lever |
| 37. | Oil bath |
| 38. | Receptacle |
| 39. | Housing section |
| 40. | Rolling body |
| 41. | Lubricant line |
| 42. | Lubricant line |
| 43. | Threaded union |
| 44. | Lubricating oil distributor |
| 45. | Line section |

We claim:

1. A closing mechanism for at least two mold sections (7, 8) of a glassware forming machine, comprising:
at least two mold holders (4, 5) configured to hold the at least two mold sections (7, 8);
a station housing (1) having an upper side (2) and a housing section (3) supported on the upper side (2) of the station housing (1);
a drivetrain encompassing a gearing and a drive, wherein the at least two mold holders (4, 5) are positioned to be horizontally movable by via the drivetrain between an opening position of the at least two mold sections mold (7, 8) and a closing position;
a guide configured to horizontally move the at least two mold holders (4, 5), said guide positioned inside of the housing section (3) above the upper side (2) of the station housing (12) and laterally relative to the station housing (1);
wherein the drive and the gearing of the drivetrain are arranged under the upper side (2) inside of the station housing (1), wherein the drivetrain is suspended under the housing section (3) inside of the station housing (1), and wherein the housing section (3) is supported on the upper side (2) of the housing section (1).

2. The closing mechanism according to claim 1, wherein the guide is a linear guide (19).

3. The closing mechanism according to claim 1, wherein the drive is configured to create a vertically oriented linear movement on the outlet side.

4. The closing mechanism according to claim 1, wherein the drive is comprised of a motor (11), a threaded spindle (12), a threaded sleeve (13), and a rod (18).

5. The closing mechanism according to claim 1, wherein the drive is comprised of a piston-cylinder unit.

6. The closing mechanism according to claim 1, further comprising a linear guide (19), mounting plates (9, 10), and guiding elements (20), wherein the mold holders (4, 5) are mounted on the linear guide (19) via said mounting plates (9, 10) and guiding elements (20).

7. The closing mechanism according to claim 6, wherein the gearing is configured to convert vertical linear movement on an inlet side into two horizontally opposite movements that are symmetrical relative to a vertical central plane.

8. The closing mechanism according to claim 7, wherein the gearing is a toggle-lever mechanism (14).

9. The closing mechanism according to claim 1, wherein a receptacle (38) that accommodates an oil bath (37) is set up under the housing section (3) and inside of the station housing (1), and wherein at least the gearing is situated inside of the oil bath (37).

10. The closing mechanism according to claim 9, wherein the gearing is mounted inside of or via the receptacle (38).

11. The closing mechanism according to claim 9, wherein a central lubricating system is set up for lubrication points outside of the oil bath (37).

12. The closing mechanism according to claim 11, wherein each lubrication point is provided with a lubricant line (41, 42) proceeding from a lubricating oil distributor (44).

13. The closing mechanism according to claim 8, wherein the toggle-lever mechanism (14) exhibits a central, horizontally extending shaft (15) that can be rotatably driven by the drive, wherein the central, horizontally extending shaft (15) is drivingly connected via two identical, oppositely drivable levers (23, 24) and intermediate levers (29, 30) with a further, respective shaft (27, 28) that extends horizontally and parallel to the central, horizontally extending shaft (15), and wherein the further, respective shafts (27, 28) are each drivingly connected via an intermediate lever (34, 35) that forms a toggle-lever system and a connecting lever (33, 36) with the mounting plates (9, 10), moving the mounting plates (9, 10) in opposite directions between the opening position and closing position of the mold halves (7, 8).

14. The closing mechanism according to claim 13, wherein the central, horizontally extending shaft and the further, respective shafts (15, 27, 28) are mounted inside of or via the receptacle (38).
